(19) United States
(12) Patent Application Publication
(10) Pub. No.: US 2025/0323002 A1
(43) Pub. Date: Oct. 16, 2025

(54) Relay Armature Assembly, Relay Module and Relay

(71) Applicant: Tyco Electronics (Shanghai) Co., Ltd., Shanghai (CN)

(72) Inventors: Jun (Tod) Chen, Shenzhen (CN); Jinlin Xu, Shanghai (CN)

(73) Assignee: Tyco Electronics (Shanghai) Co., Ltd., Shanghai (CN)

(21) Appl. No.: 19/175,691

(22) Filed: Apr. 10, 2025

(30) Foreign Application Priority Data
Apr. 10, 2024 (CN) 202410432811.2

(51) Int. Cl. H01H 50/18; H01H 50/44; H01H 50/54

(52) U.S. Cl. CPC H01H 50/18; H01H 50/44; H01H 50/54

(57) ABSTRACT

The present invention discloses a relay armature assembly, a relay module, and a relay. The relay armature assembly comprises: an armature which is suitable for being movably installed on a yoke of a relay, and can swing relative to the yoke between an initial position and a suction position; a movable leaf spring adapted to be connected to a movable contact assembly of the relay, for applying elastic contact force to the movable contact assembly; and an insulator. The armature and the movable leaf spring are fixed to the insulator and electrically isolated from each other by the insulator. In the present invention, the movable leaf spring is directly connected to the insulator, reducing the number of components of the relay, simplifying the structure of the relay, reducing the cost of the relay, and improving the manufacturing efficiency of the relay. In addition, in some embodiments of the present invention, the reset leaf spring is fixed to the yoke. Therefore, when the reset leaf spring is frequently moved, the insulation base is not affected and will not break or wear, thereby improving the service life and reliability of the relay.

### CROSS-REFERENCE TO RELATED APPLICATION

This application claims the benefit of Chinese Patent Application No. CN202410432811.2 filed on Apr. 10, 2024 in the State Intellectual Property Office of China, the whole disclosure of which is incorporated herein by reference.

### FIELD OF THE INVENTION

The present invention relates to a relay armature assembly, a relay module comprising the relay armature assembly and a relay comprising the relay module.

### BACKGROUND

An electromagnetic relay typically includes an insulation base, a movable contact, a static contact, and a movable leaf spring. The insulation base includes a peripheral wall, a bottom wall, and a partition wall. The partition wall divides the space inside the insulation base into a containment chamber and an arc extinguishing chamber. The movable contact, static contact, and movable leaf spring are set in the arc extinguishing chamber. The movable contact is fixed to the end of the movable leaf spring. In order to increase the length of the movable leaf spring, the end of the movable leaf spring is usually made close to the bottom wall of the insulation base, which results in a too short distance between the movable contact and the bottom wall of the insulation base. When extinguishing the electric arc with magnetic force, the length of the electric arc pulled down between the movable contact and the static contact is limited, making it difficult to elongate to a predetermined length, which can reduce the effectiveness of the magnetic extinguishing arc and even cause arc extinguishing failure. Once the electric arc cannot be quickly extinguished, it will cause the movable and static contacts to be melted by the high temperature generated by the electric arc, and even cause the electromagnetic relay to explode, seriously affecting safety production.

In addition, in the prior art, a relay also includes a yoke, an armature, an insulator, and a connecting piece. The armature is movably installed on the yoke and can swing relative to the yoke between the suction position and the initial position. One end of the armature is connected to the insulator. One end of the connecting piece is joined to the insulator. The insulator electrically isolates the armature from the connecting piece. The movable leaf spring of the relay is riveted to the other end of the connecting piece. In the prior art, the need to provide separate connection pieces increases the number of components in the relay, resulting in increased costs. Moreover, riveting the movable leaf spring and the connecting piece will reduce production efficiency.

In addition, in the prior art, the relay also includes a reset leaf spring for resetting the armature from the suction position to the initial position. The reset leaf spring is usually fixed to the partition wall of the insulation base. Due to the fact that the insulation base is usually made of plastic, its mechanical strength and wear resistance are poor. When the reset leaf spring is frequently moved, the partition wall of the insulation base is prone to rupture or wear. The plastic dust generated by wear can affect the electrical contact performance between movable and static contacts.

### SUMMARY

The present invention has been made to overcome or alleviate at least one aspect of the above-mentioned disadvantages.

According to an aspect of the present invention, there is provided a relay armature assembly. The relay armature assembly comprises: an armature which is suitable for being movably installed on a yoke of a relay, and can swing relative to the yoke between an initial position and a suction position; a movable leaf spring adapted to be connected to a movable contact assembly of the relay, for applying elastic contact force to the movable contact assembly; and an insulator. The armature and the movable leaf spring are fixed to the insulator and electrically isolated from each other by the insulator.

According to an exemplary embodiment of the present invention, the insulator is an injection molded part directly formed on the armature and the movable leaf spring through an embedded injection molding process, so that the armature, the movable leaf spring, and the insulator are integrated into one piece.

According to another exemplary embodiment of the present invention, the armature and the movable leaf spring are respectively joined to the upper and lower sides of the insulator, and grooves and/or ribs are formed on the front and rear sides of the insulator to increase the creepage distance between the armature and the movable leaf spring.

According to another exemplary embodiment of the present invention, the movable leaf spring comprises: a sheet-like body; and multiple bent wings connected to one end of the sheet-like body and bent vertically relative to the sheet-like body, one end of the sheet-like body and the multiple bent wings are joined into the insulator to increase the bonding force between the movable leaf spring and the insulator.

According to another exemplary embodiment of the present invention, through holes are formed in one end of the sheet-like body and in the bent wing respectively to engage with the insulator, in order to further increase the bonding force between the movable leaf spring and the insulator.

According to another exemplary embodiment of the present invention, a riveting hole is formed in the other end of the sheet-like body of the movable leaf spring, which is suitable for engaging with a riveting post on the movable contact assembly, so that the movable contact assembly can be riveted to the other end of the sheet-like body of the movable leaf spring.

According to another exemplary embodiment of the present invention, the armature comprises: a plate-shaped body; and a bent portion connected to one end of the plate-shaped body and bent perpendicular to the plate-shaped body. The bent portion is joined into the insulator, and the plate-shaped body is adapted to be movably mounted on the yoke, a through hole is formed in the bent portion to engage with the insulator, in order to further increase the bonding force between the armature and the insulator.

According to another aspect of the present invention, there is provided a relay module. The relay module comprises: a yoke which is fixed to the insulation base of a relay; a magnetic core with its lower end fixed to the yoke; the above relay armature assembly, wherein the armature is movably mounted on the yoke and can swing between a suction position in contact with the upper end of the magnetic core and an initial position separated from the upper end of the magnetic core; and a reset leaf spring fixed to the yoke and pressed onto the armature, used to reset the armature from the suction position to the initial position. The magnetic core and the reset leaf spring are respectively arranged on both sides of the yoke, the magnetic core is used to apply electromagnetic attraction to the armature, and the reset leaf spring is used to apply elastic reset force to the armature.

According to an exemplary embodiment of the present invention, the yoke comprises: a vertical plate with a notch formed at the upper end of the vertical plate; and a horizontal plate connected to the lower end of the vertical plate. A neck is formed on the plate-shaped body of the armature, the neck is movably engaged in the notch of the yoke.

According to another exemplary embodiment of the present invention, the reset leaf spring comprises: a vertical spring piece fixed to the vertical plate of the yoke; and a pressing spring piece connected to the upper end of the vertical spring piece and bent at a predetermined angle relative to the vertical spring piece. A mounting port is formed in one end of the plate-shaped body of the armature to allow the vertical spring piece to pass through, and the pressing spring piece is pressed on one side of the mounting port of the armature to apply elastic reset force to the armature.

According to another exemplary embodiment of the present invention, a snap slot is formed in the vertical plate of the yoke, and an elastic buckle is formed on the vertical spring piece of the reset leaf spring, the elastic buckle is engaged into the snap slot to fix the reset leaf spring to the yoke.

According to another exemplary embodiment of the present invention, the reset leaf spring further comprises a limit spring piece connected to the upper end of the vertical spring piece and located above the other side of the mounting port of the armature, the limit spring piece is used to constrain the neck of the armature in the notch of the yoke to prevent the armature from detaching from the yoke.

According to another exemplary embodiment of the present invention, the relay module further comprises a coil assembly. The coil assembly includes: a coil skeleton with a central through-hole; a coil wound around the coil skeleton; and two coil terminals fixed to the coil skeleton and connected to both ends of the coil, respectively. The magnetic core is installed in the central through-hole of the coil skeleton, and the upper end of the magnetic core is exposed from the outside of the coil skeleton for adsorbing the armature.

According to another aspect of the present invention, there is provided a relay. The relay comprises: a housing with a bottom opening; the above relay module arranged in the housing; an insulation base installed into the bottom opening of the housing; and two static contact assemblies fixed to the insulation base for electrical contact with a movable contact assembly.

According to an exemplary embodiment of the present invention, the movable contact assembly comprises: a movable terminal fixed to the movable leaf spring; and two movable contacts respectively fixed to both ends of the movable terminal. The static contact assembly comprises: a static terminal fixed to the insulation base; and a static contact fixed to the static terminal. The two movable contacts are used to make electrical contact with the static contacts of the two static contact assemblies, respectively, to electrically connect the static terminals of the two static contact assemblies.

According to another exemplary embodiment of the present invention, when the armature is attracted to the suction position, the two movable contacts are moved to a closed position in electrical contact with the two static contacts respectively; when the armature is reset to the initial position, the two movable contacts are moved to an open position separated from the two static contacts.

According to another exemplary embodiment of the present invention, the insulation base comprises: a peripheral wall; a bottom wall connected to the bottom of the peripheral wall; and a partition wall connected to the peripheral wall and the bottom wall. The partition wall divides an internal space defined by the housing and the insulation base into a containment chamber and an arc extinguishing chamber, the coil assembly and the yoke are arranged in the accommodating chamber, and the movable contact assembly and the static contact assembly are arranged in the arc extinguishing chamber.

According to another exemplary embodiment of the present invention, the relay further comprises two arc extinguishing magnets which are arranged in the arc extinguishing chamber, two recesses are formed on the inner side of the bottom wall of the arc extinguishing chamber, the two recesses are respectively located below the two movable contacts and between the two arc extinguishing magnets, so that an electric arc between one static contact and one movable contact of the relay can be pulled down into the recess by a magnetic field between the two arc extinguishing magnets to increase the length of the electric arc being pulled down.

According to another exemplary embodiment of the present invention, the insulation base further comprises two magnet retaining portions which are formed in the arc extinguishing chamber, a slot is formed in the magnet retaining portion, and the two arc extinguishing magnets are respectively inserted into the slots of the two magnet retaining portions.

According to another exemplary embodiment of the present invention, the slot has an insertion port located on the outer side of the bottom wall, and the arc extinguishing magnet is inserted into the slot of the magnet retaining portion through the insertion port.

According to another exemplary embodiment of the present invention, the insulation base further comprises two terminal holding portions which are formed in the arc extinguishing chamber, a terminal slot is formed in the terminal holding portion, and the two static terminals are respectively inserted into the terminal slots of the two terminal holding portions.

According to another exemplary embodiment of the present invention, the peripheral wall of the insulation base is inserted into the housing through the bottom opening of the housing, and a protrusion is formed on the outer side of the peripheral wall of the insulation base, a slot hole is formed in the peripheral wall of the housing, and the protrusion is engaged with the slot hole to fix the housing to the insulation base.

According to another exemplary embodiment of the present invention, a vertical slot is formed in one side of the partition wall of the insulation base facing the vertical plate of the yoke, and the vertical spring piece of the reset leaf spring is inserted into the vertical slot of the partition wall.

In the aforementioned exemplary embodiments according to the present invention, the movable leaf spring is directly joined into the insulator, reducing the number of components of the relay, simplifying the structure of the relay, reducing the cost of the relay, and improving the manufacturing efficiency of the relay.

In the aforementioned exemplary embodiments according to the present invention, the reset leaf spring is fixed to the yoke. Therefore, when the reset leaf spring is frequently moved, the insulation base is not affected and will not break or wear, thereby improving the service life and reliability of the relay.

In the aforementioned exemplary embodiments according to the present invention, the electric arc between one movable contact and one static contact of the relay can be pulled down into the recess on the bottom wall of the arc extinguishing chamber by the magnetic field between the two arc extinguishing magnets. Therefore, the length of the electric arc pulled down can be increased, allowing the electric arc to be quickly extinguished, greatly improving the magnetic extinguishing effect of the relay.

### BRIEF DESCRIPTION OF THE DRAWINGS

The above and other features of the present invention will become more apparent by describing in detail exemplary embodiments thereof with reference to the accompanying drawings, in which:

FIG. 1 shows an illustrative perspective view of a relay according to an exemplary embodiment of the present invention;

FIG. 2 shows a transverse sectional view of a relay according to an exemplary embodiment of the present invention;

FIG. 3 shows a longitudinal sectional view of a relay insulation base and housing according to an exemplary embodiment of the present invention;

FIG. 4 shows a transverse sectional view of a relay according to an exemplary embodiment of the present invention, where the housing is not shown;

FIG. 5 shows a longitudinal sectional view of a relay according to an exemplary embodiment of the present invention, where the housing is not shown;

FIG. 6 shows a plan sectional view of a relay according to an exemplary embodiment of the present invention, in which the movable contact and the static contact are in an electrically separated open position;

FIG. 7 shows a plan sectional view of a relay according to an exemplary embodiment of the present invention, in which the movable contact and the static contact are in the closed position of electrical contact;

FIG. 8 shows an illustrative perspective view of a relay module according to an exemplary embodiment of the present invention;

FIG. 9 shows a cross-sectional view of a relay module according to an exemplary embodiment of the present invention;

FIG. 10 shows an illustrative exploded view of a relay module according to an exemplary embodiment of the present invention;

FIG. 11 shows an exploded sectional view of a relay module according to an exemplary embodiment of the present invention;

FIG. 12 shows an illustrative exploded view of a relay armature assembly according to an exemplary embodiment of the present invention;

FIG. 13 shows an illustrative assembly view of the yoke and reset leaf spring of a relay according to an exemplary embodiment of the present invention;

FIG. 14 shows an illustrative perspective view of the reset leaf spring of a relay according to an exemplary embodiment of the present invention;

FIG. 15 shows a cross-sectional view of the reset leaf spring of a relay according to an exemplary embodiment of the present invention;

FIG. 16 shows a cross-sectional view of the yoke and reset leaf spring of a relay according to an exemplary embodiment of the present invention; and

FIG. 17 shows a cross-sectional view of the yoke, reset leaf spring, and insulation base of a relay according to an exemplary embodiment of the present invention.

### DETAILED DESCRIPTION OF EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general concept of the present invention, there is provided an insulation base for installation into a bottom opening of a housing of a relay. The insulation base comprises: a peripheral wall; a bottom wall connected to the bottom of the peripheral wall; and a partition wall connected to the peripheral wall and the bottom wall. The partition wall is used to divide an internal space defined by the housing and the insulation base into a containment chamber and an arc extinguishing chamber; two recesses are formed on the inner side of the bottom wall of the arc extinguishing chamber, so that an electric arc between a static contact and a movable contact of the relay can be pulled down into the recess to increase the length of the electric arc being pulled down.

According to another general concept of the present invention, there is provided a relay. The relay comprises: a housing formed with a bottom opening; the above insulation base installed into the bottom opening of the housing; two static contacts located in the arc extinguishing chamber; two movable contacts located in the arc extinguishing chamber for electrical contact with the two static contacts respectively; and two arc extinguishing magnets located in the arc extinguishing chamber for extinguishing an electric arc between the static contact and the movable contact by magnetic blowing. The two recesses on the bottom wall of the arc extinguishing chamber are respectively located below the two movable contacts and between the two arc extinguishing magnets, so that the electric arc between the static contact and the movable contact can be pulled down into the recess by a magnetic field between the two arc extinguishing magnets.

According to another general concept of the present invention, there is provided a relay armature assembly. The relay armature assembly comprises: an armature which is suitable for being movably installed on a yoke of a relay, and can swing relative to the yoke between an initial position and a suction position; a movable leaf spring adapted to be connected to a movable contact assembly of the relay, for applying elastic contact force to the movable contact assembly; and an insulator. The armature and the movable leaf spring are fixed to the insulator and electrically isolated from each other by the insulator.

According to another general concept of the present invention, there is provided a relay module. The relay module comprises: a yoke which is fixed to the insulation base of a relay; a magnetic core with its lower end fixed to the yoke; the above relay armature assembly, wherein the armature is movably mounted on the yoke and can swing between a suction position in contact with the upper end of the magnetic core and an initial position separated from the upper end of the magnetic core; and a reset leaf spring fixed to the yoke and pressed onto the armature, used to reset the armature from the suction position to the initial position. The magnetic core and the reset leaf spring are respectively arranged on both sides of the yoke, the magnetic core is used to apply electromagnetic attraction to the armature, and the reset leaf spring is used to apply elastic reset force to the armature.

According to another general concept of the present invention, there is provided a relay. The relay comprises: a housing with a bottom opening; the above relay module arranged in the housing; an insulation base installed into the bottom opening of the housing; and two static contact assemblies fixed to the insulation base for electrical contact with a movable contact assembly.

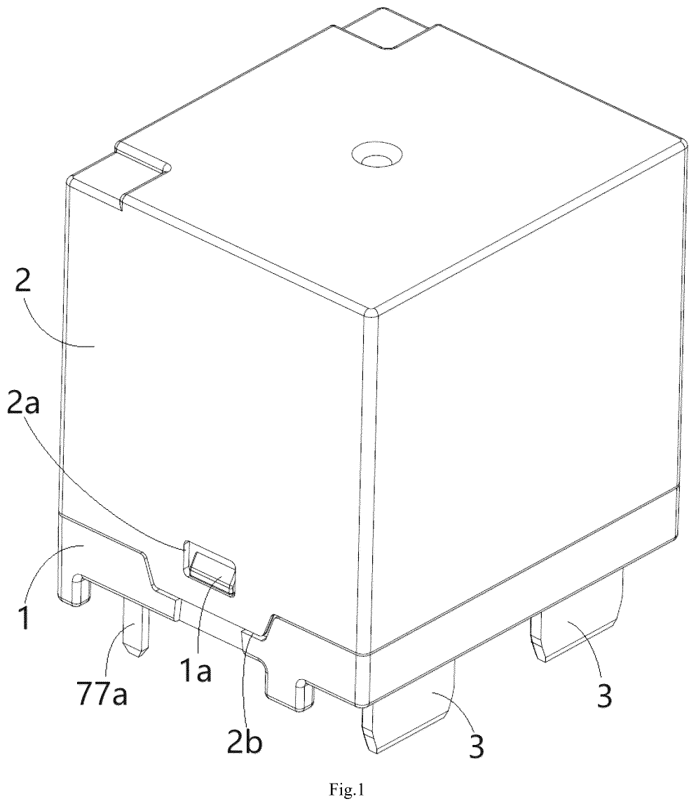

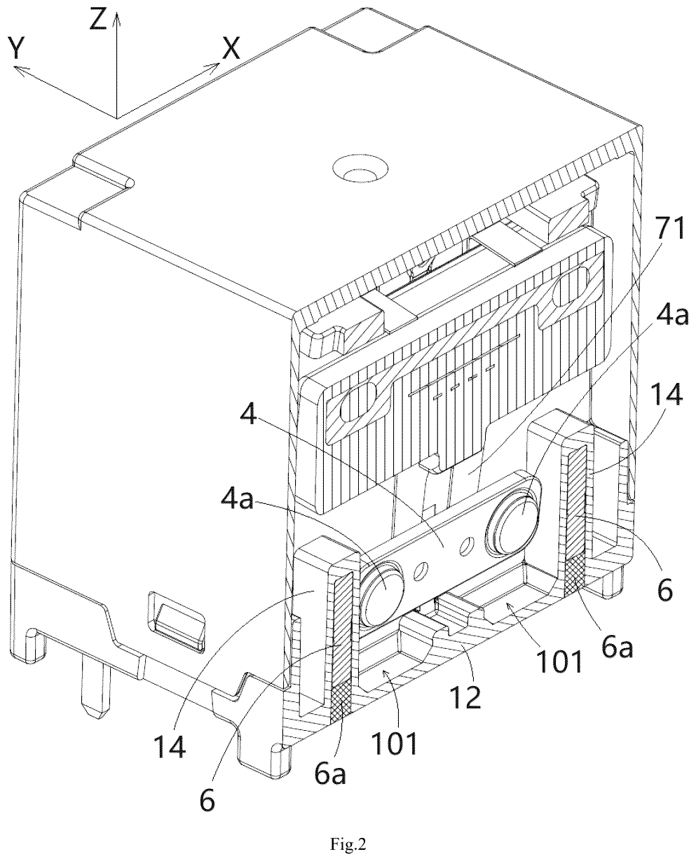

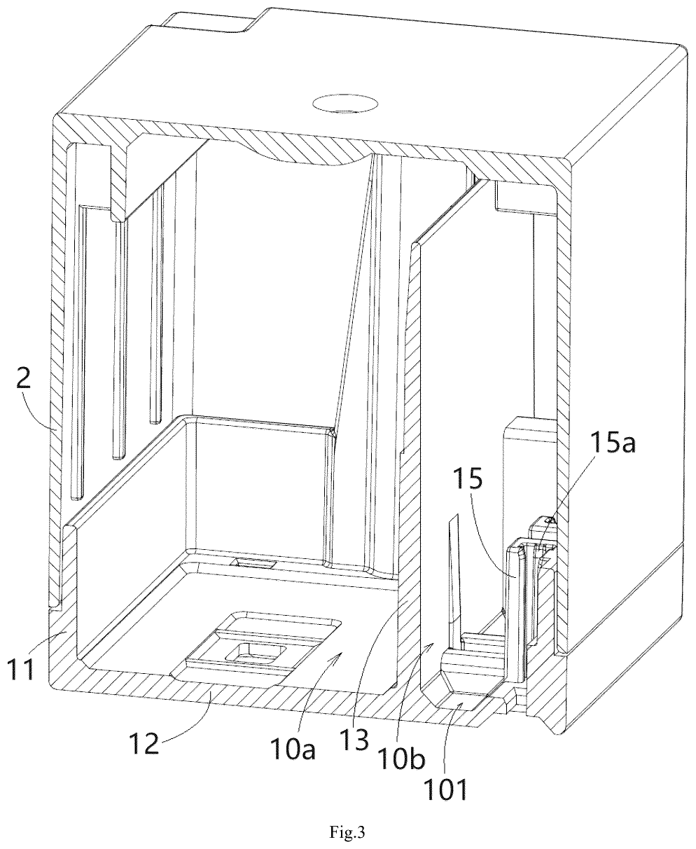

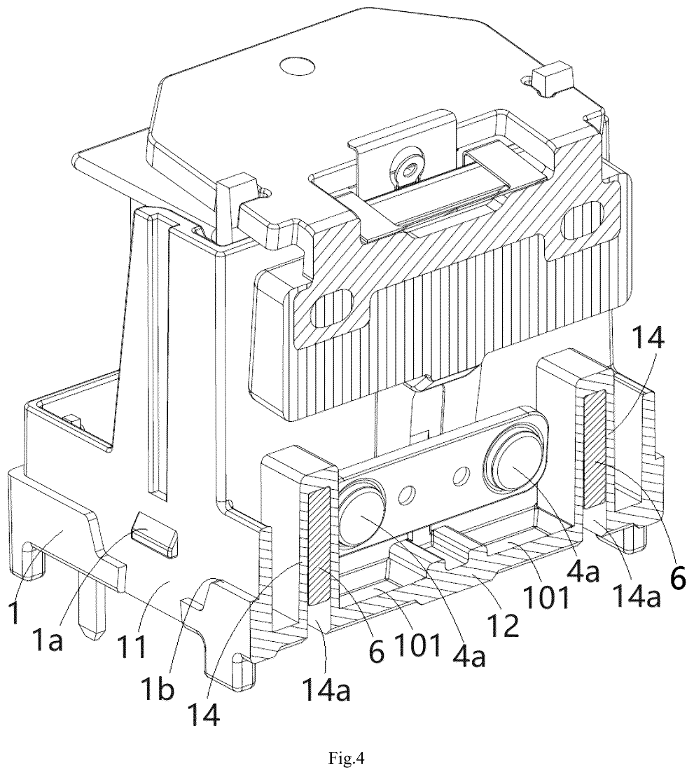

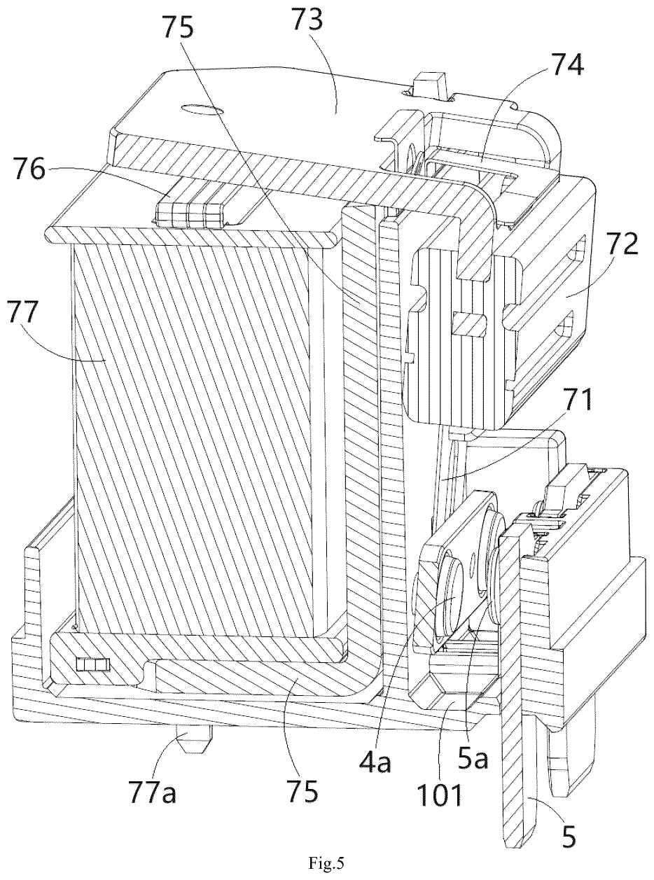

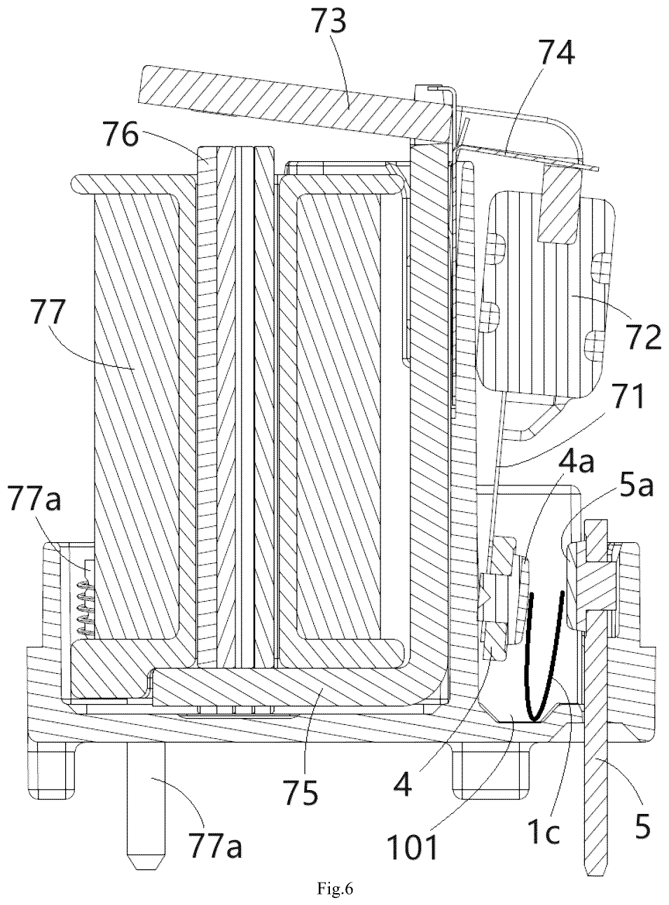

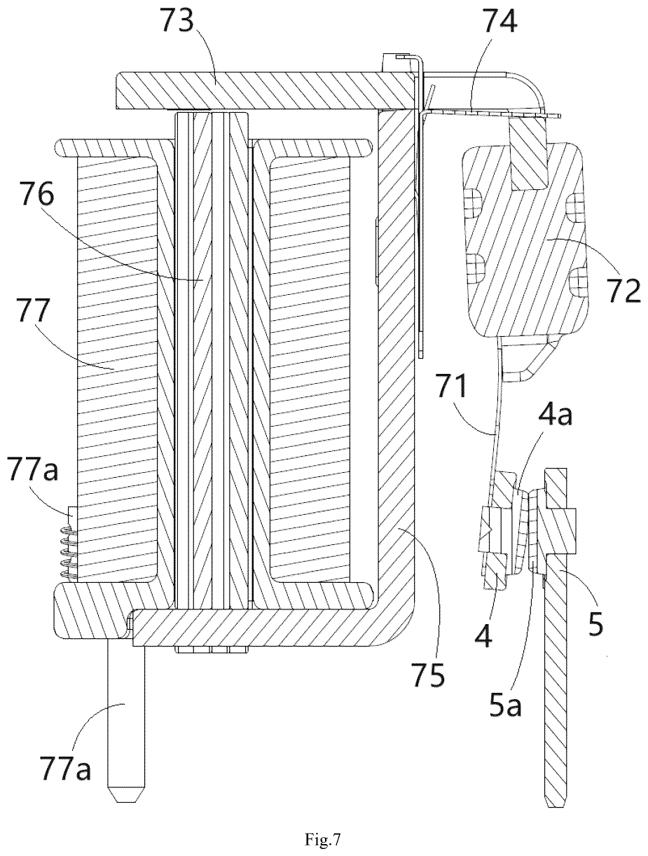

FIG. 1 shows an illustrative perspective view of a relay according to an exemplary embodiment of the present invention; FIG. 2 shows a transverse sectional view of a relay according to an exemplary embodiment of the present invention; FIG. 3 shows a longitudinal sectional view of a relay insulation base 1 and a housing 2 according to an exemplary embodiment of the present invention; FIG. 4 shows a transverse sectional view of a relay according to an exemplary embodiment of the present invention, where the housing 2 is not shown; FIG. 5 shows a longitudinal sectional view of a relay according to an exemplary embodiment of the present invention, wherein the housing 2 is not shown; FIG. 6 shows a plan sectional view of a relay according to an exemplary embodiment of the present invention, in which the movable contact 4a and the static contact 5a are in an electrically separated open position; FIG. 7 shows a plan sectional view of a relay according to an exemplary embodiment of the present invention, where the movable contact 4a and the static contact 5a are in the closed position of electrical contact.

As shown in FIGS. 1 to 7, in an exemplary embodiment of the present invention, an insulation base 1 is disclosed. The insulation base 1 is used for installation into a bottom opening of a housing 2 of a relay. The insulation base 1 includes a peripheral wall 11, a bottom wall 12, and a partition wall 13. The bottom wall 12 is connected to the bottom of the peripheral wall 11. The partition wall 13 is connected to the peripheral wall 11 and the bottom wall 12. The partition wall 13 is used to divide the internal space defined by the housing 2 and the insulation base 1 into a containment chamber 10a and an arc extinguishing chamber 10b. Two recesses 101 are formed on the inner side of the bottom wall 12 of the arc extinguishing chamber 10b, so that the electric arc 1c between one static contact 5a and one movable contact 4a of the relay can be pulled down into one recess 101 to increase the length of the electric arc 1c being pulled down.

As shown in FIGS. 1 to 7, in the illustrated embodiment, the electric arc 1c between one movable contact 4a and one static contact 5a of the relay can be pulled down into the recess 101 on the bottom wall 12 of the arc extinguishing chamber 10b by the magnetic field between the two arc extinguishing magnets 6. Therefore, the length of the electric arc 1c being pulled down can be increased, so that the electric arc 1c can be quickly extinguished, greatly improving the magnetic extinguishing effect of the relay. In addition, the electric arc between the other static contact 5a and the other movable contact 4a of the relay is stretched upwards by the magnetic field between the two arc extinguishing magnets 6. Due to the large space for upward stretching, the upward stretched arc can also be quickly extinguished.

As shown in FIGS. 1 to 7, in the illustrated embodiment, the insulation base 1 has a transverse direction X, a longitudinal direction Y, and a height direction Z, the partition wall 13 extends along the transverse direction X and height direction Z, and two recesses 101 are arranged side by side in the transverse direction X.

As shown in FIGS. 1 to 7, in the illustrated embodiment, the insulation base 1 further includes two magnet retaining portions 14. Two magnet retaining portions 14 are formed in the arc extinguishing chamber 10b for holding the two arc extinguishing magnets 6 of the relay. Two magnet retaining portions 14 are opposite in the transverse direction X, and two recesses 101 are located between the two magnet retaining portions 14.

As shown in FIGS. 1 to 7, in the illustrated embodiment, the magnet retaining portion 14 is connected to the bottom wall 12 and the partition wall 13, and slots 14a for inserting arc extinguishing magnets 6 are formed in each of the two magnet retaining portions 14. The two arc extinguishing magnets 6 of the relay are adapted to be inserted into the slots 14a of the two magnet retaining portions 14, respectively.

As shown in FIGS. 1 to 7, in the illustrated embodiment, the slot 14a has an insertion port located on the outer side of the bottom wall 12 to allow the arc extinguishing magnet 6 to be inserted into the slot 14a of the magnet retaining portion 14 through the insertion port.

As shown in FIGS. 1 to 7, in the illustrated embodiment, the inner wall surface of the slot 14a is suitable for interference fit with the arc extinguishing magnet 6 to fix the arc extinguishing magnet 6 in the slot 14a.

As shown in FIGS. 1 to 7, in another exemplary embodiment of the present invention, there is a gap between the inner wall surface of the slot 14a and the arc extinguishing magnet 6, and a sealant 6a is injected into the insertion port of the slot 14a to seal the insertion port of the slot 14a and fix the arc extinguishing magnet 6 in the slot 14a.

As shown in FIGS. 1 to 7, in the illustrated embodiment, the insulation base 1 also includes two terminal holding portions 15. Two terminal holding portions 15 are formed in the arc extinguishing chamber 10b for holding the two static terminals 5 of the relay. The two terminal holding portions 15 are arranged side by side in the transverse direction X and are spaced opposite to the partition wall 13.

As shown in FIGS. 1 to 7, in the illustrated embodiment, the terminal holding portion 15 is connected to the peripheral wall 11 and the bottom wall 12, and terminal slots 15a for inserting static terminals 55 are formed in each of the two terminal holding portions 15. The two static terminals 5 of the relay are suitable for being inserted into the terminal slots 15a of the two terminal holding portions 15, respectively.

As shown in FIGS. 1 to 7, in the illustrated embodiment, an opening is formed in the bottom wall 12 that communicates with the terminal slot 15a to allow a portion of the static terminal 55 to protrude from the insulation base 1 through the opening on the bottom wall 12.

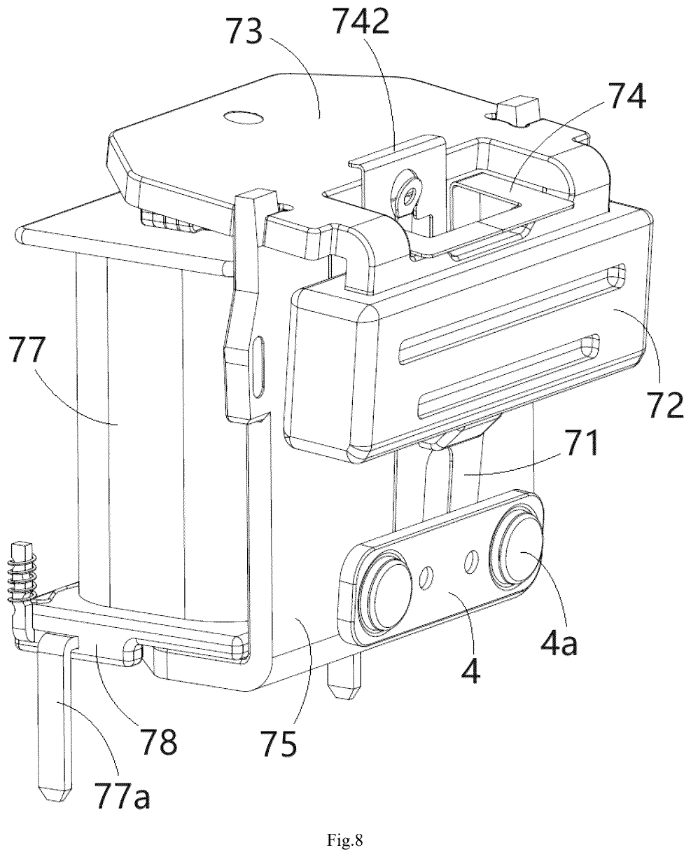

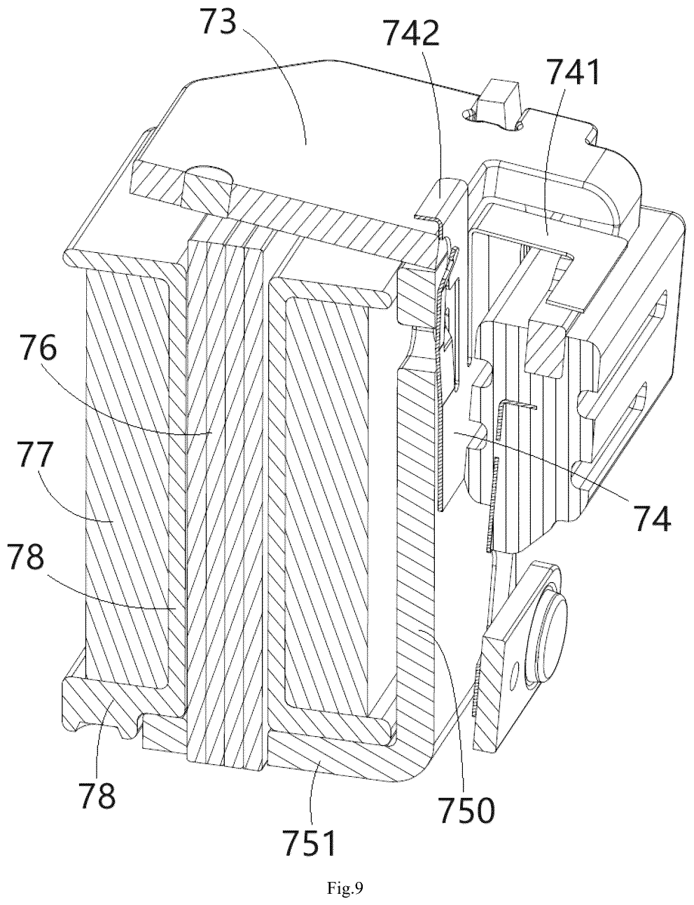

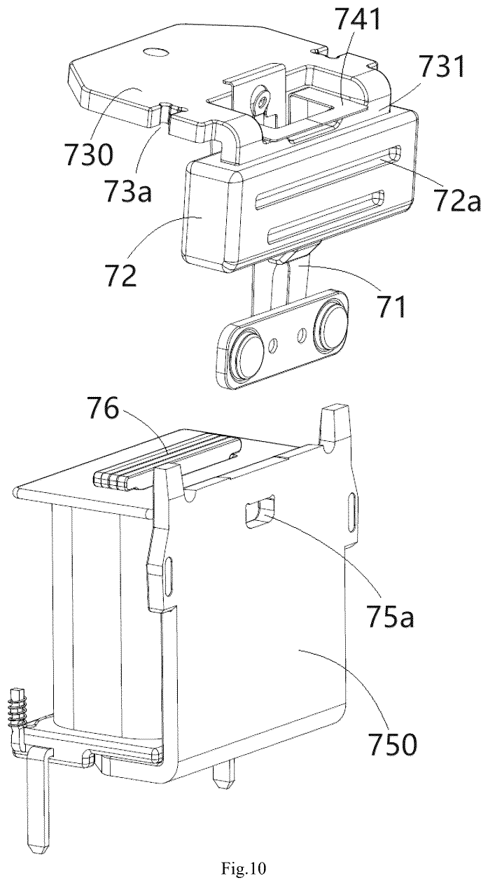

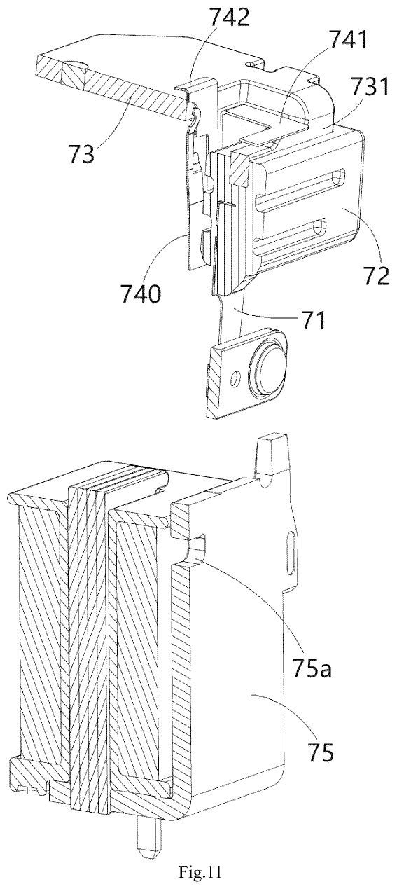

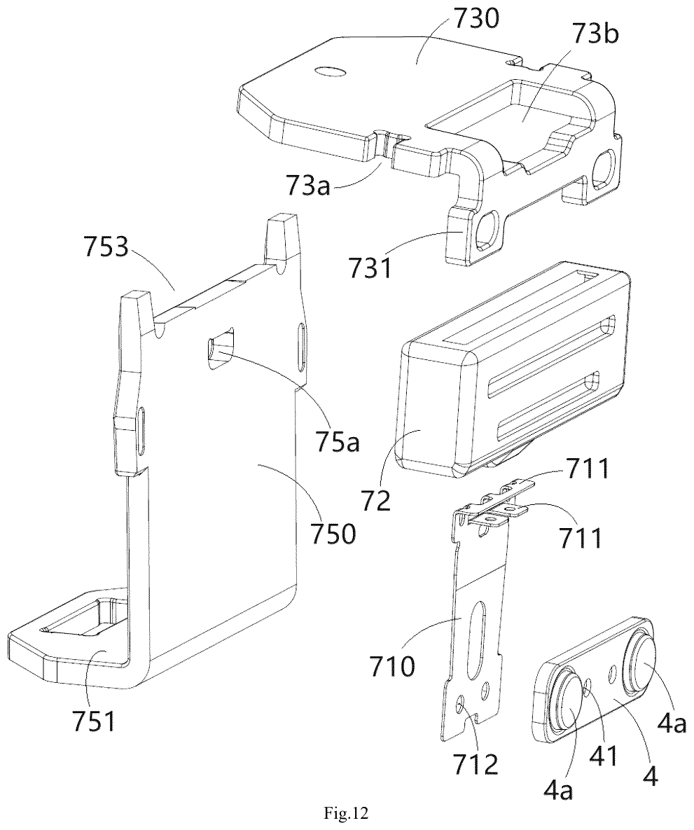

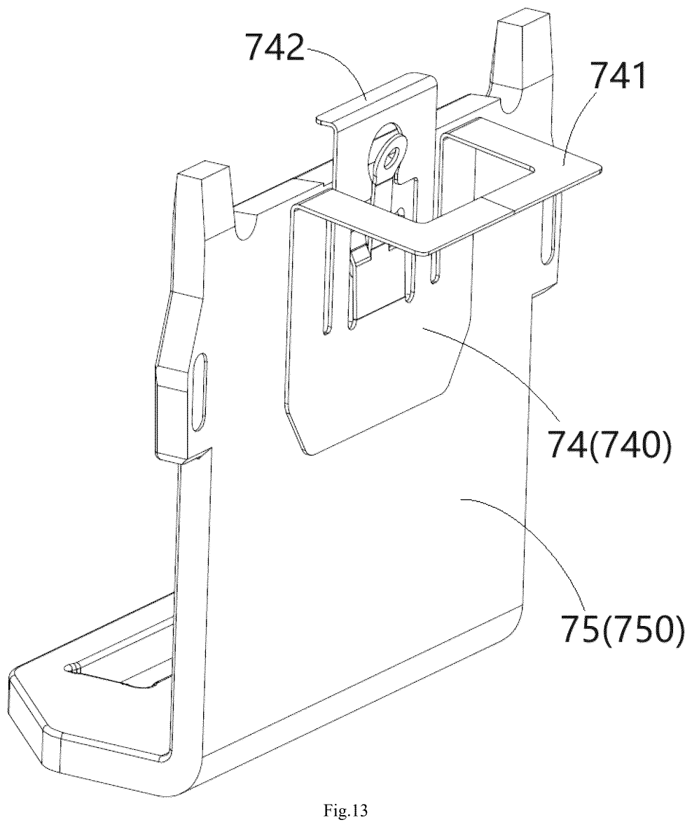

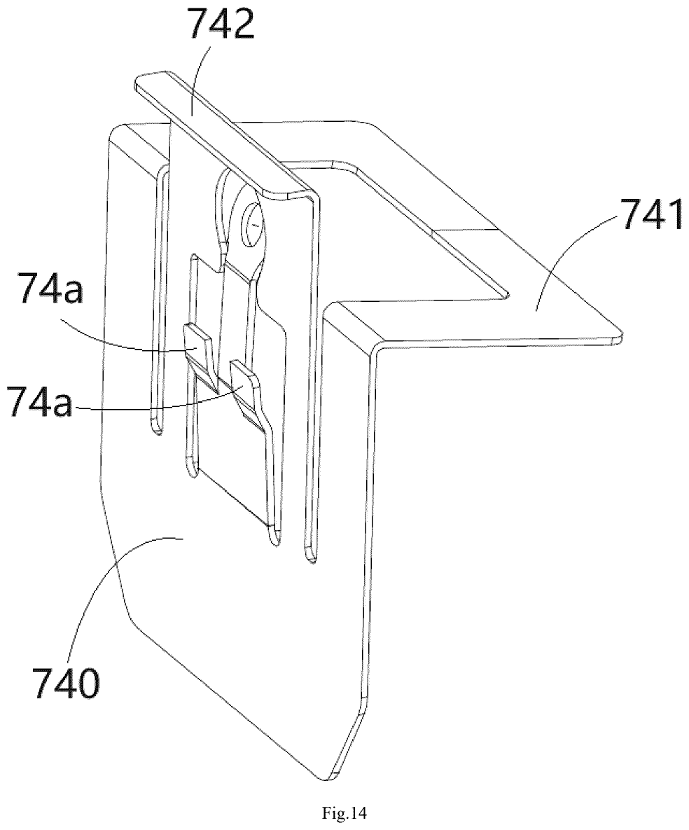

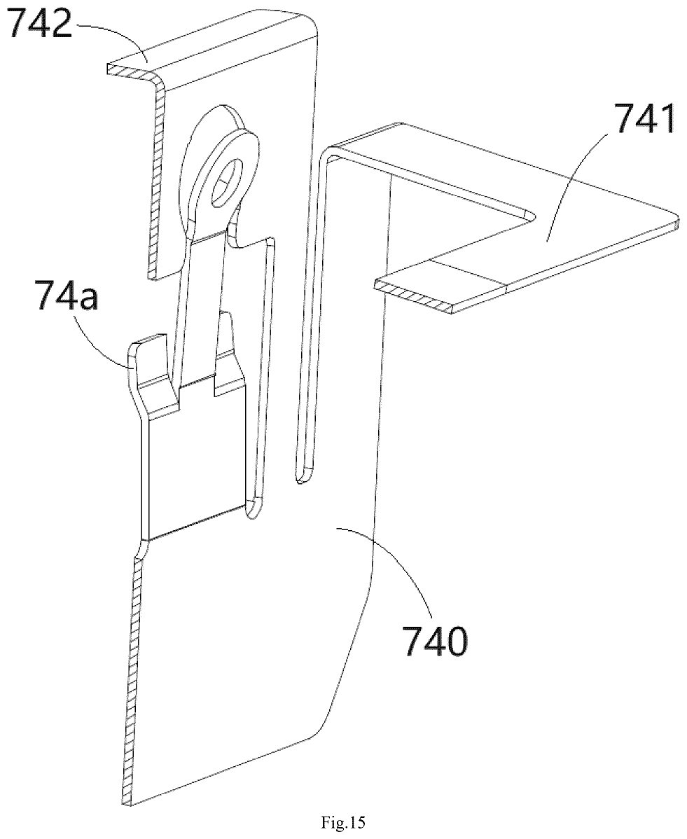

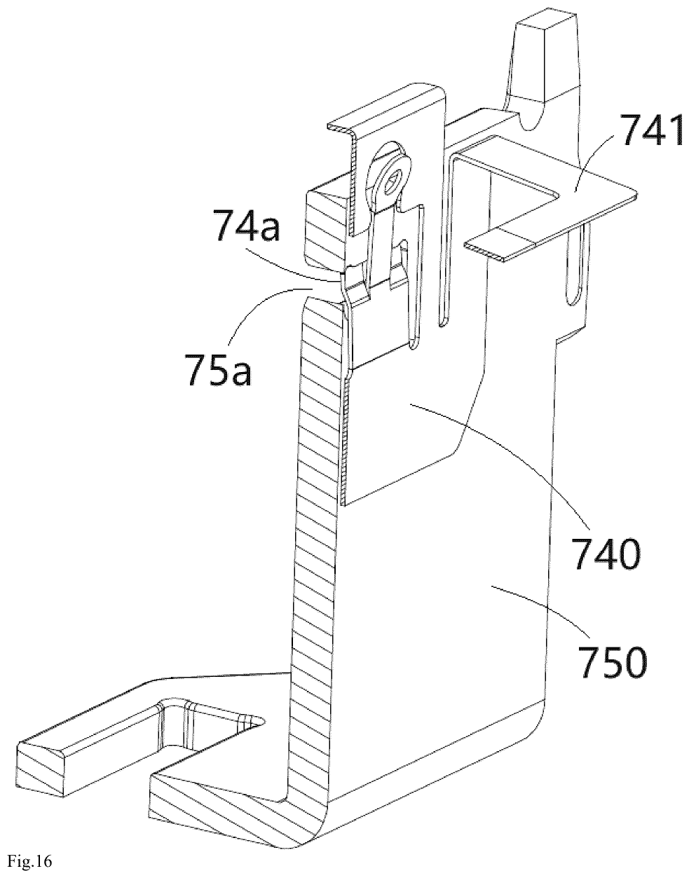

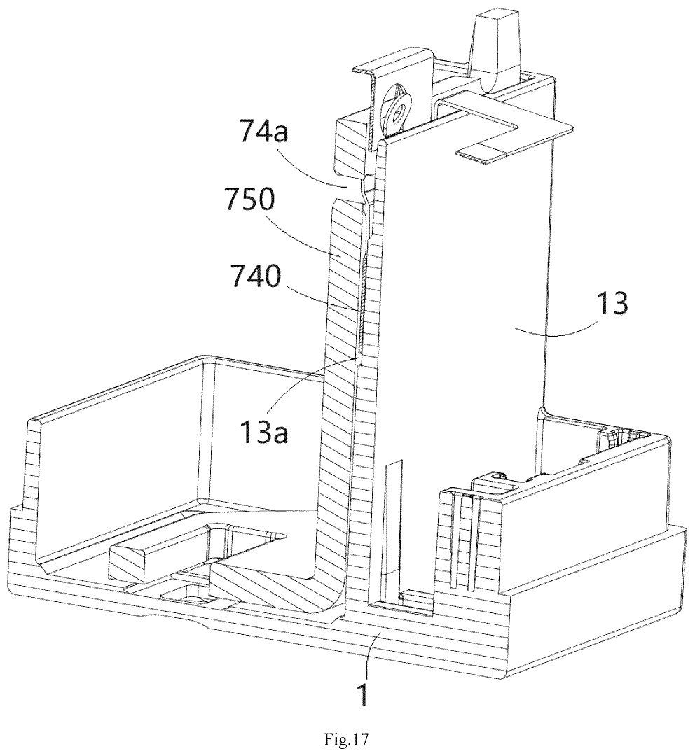

FIG. 8 shows an illustrative perspective view of a relay module according to an exemplary embodiment of the present invention; FIG. 9 shows a cross-sectional view of a relay module according to an exemplary embodiment of the present invention; FIG. 10 shows an illustrative exploded view of a relay module according to an exemplary embodiment of the present invention; FIG. 11 shows an exploded sectional view of a relay module according to an exemplary embodiment of the present invention; FIG. 12 shows an illustrative exploded view of a relay armature assembly according to an exemplary embodiment of the present invention; FIG. 13 shows an illustrative assembly view of the yoke 75 and reset leaf spring 74 of a relay according to an exemplary embodiment of the present invention; FIG. 14 shows an illustrative perspective view of the reset leaf spring 74 of a relay according to an exemplary embodiment of the present invention; FIG. 15 shows a cross-sectional view of the reset leaf spring 74 of a relay according to an exemplary embodiment of the present invention; FIG. 16 shows a cross-sectional view of the yoke 75 and reset leaf spring 75 of a relay according to an exemplary embodiment of the present invention; FIG. 17 shows a cross-sectional view of the yoke 75, reset leaf spring 74, and insulation base 1 of a relay according to an exemplary embodiment of the present invention.

As shown in FIGS. 1 to 17, in another exemplary embodiment of the present invention, a relay is also disclosed, which may be a DC electromagnetic relay. The relay includes: a housing 2, an insulation base 1, two static contacts 5a, two movable contacts 4a, and two arc extinguishing magnets 6. The housing 2 is formed with a bottom opening. The insulation base 1 is installed into the bottom opening of the housing 2. Two static contacts 5a are located in the arc extinguishing chamber 10b. Two movable contacts 4a are located in the arc extinguishing chamber 10b, for electrical contact with two static contacts 5a respectively. Two arc extinguishing magnets 6 are located in the arc extinguishing chamber 10b, used to extinguish the electric arc 1c between the static contact 5a and the movable contact 4a by magnetic blowing. The two recesses 101 on the bottom wall 12 of the arc extinguishing chamber 10b are located below the two movable contacts 4a and between the two arc extinguishing magnets 6, so that the electric arc 1c between one static contact 5a and one movable contact 4a of the relay can be pulled down into the recess 101 by the magnetic field between the two arc extinguishing magnets 6. Therefore, it is possible to increase the length of the electric arc 1c being pulled down, so that the electric arc 1c can be quickly extinguished, greatly improving the magnetic extinguishing effect of the relay. In addition, the electric arc between the other static contact 5a and the other movable contact 4a of the relay is stretched upwards by the magnetic field between the two arc extinguishing magnets 6. Due to the large space for upward stretching, the upward stretched electric arc can also be quickly extinguished.

As shown in FIGS. 1 to 17, in the illustrated embodiment, the arc extinguishing magnet 6 is inserted into the slot 14a of the magnet retaining portion 14 of the insulation base 1, and sealant 6a is poured into the insertion port of the slot 14a to seal the insertion port of the slot 14a and hold the arc extinguishing magnet 6 in the slot 14a.

As shown in FIGS. 1 to 17, in the illustrated embodiment, the two arc extinguishing magnets 6 are rectangular in shape and face each other in the transverse direction X of the insulation base 1. The opposite sides of the two arc extinguishing magnets 6 have opposite polarities.

As shown in FIGS. 1 to 17, in the illustrated embodiment, the relay also includes two static terminals 5. Two static terminals 5 are respectively inserted into the terminal slots 15a of the two terminal holding portions 15 of the insulation base 1 and extend from the bottom wall 12 of the insulation base 1. Two static contacts 5a are respectively fixed to two static terminals 5 to be electrically connected to the two static terminals 5.

As shown in FIGS. 1 to 17, in the illustrated embodiment, the relay also includes a movable terminal 4. The movable terminal 4 is located in the arc extinguishing chamber 10b. Two movable contacts 4a are respectively fixed to both ends of the movable terminal 4 to be electrically connected to the movable terminal 4. When the two movable contacts 4a are moved to the closed position where they are in electrical contact with the two static contacts 5a, the two static terminals 5 are electrically connected together via the movable terminal 4.

As shown in FIGS. 1 to 17, in the illustrated embodiment, the relay further comprises a magnetic core 76, a yoke 75, and an armature assembly. The magnetic core 76 is set in the accommodating chamber 10a. The yoke 75 is set in the accommodating chamber 10a and fixed to the magnetic core 76. The armature assembly includes: an armature 73, a movable leaf spring 71, and an insulator 72. The armature 73 is installed on the yoke 75 in a movable manner, and can swing relative to the yoke 75 between an initial position and a suction position. The movable leaf spring 71 is suitable for being connected to the movable terminal 4, for applying elastic contact force to the movable contact 4a. The armature 73 and the movable leaf spring 71 are fixed to the insulator 72 and electrically isolated from each other by the insulator 72.

As shown in FIGS. 1 to 17, in the illustrated embodiment, the insulator 72 is an injection molded part directly formed on the armature 73 and the movable leaf spring 71 through an embedded injection molding process, so that the armature 73, the movable leaf spring 71, and the insulator 72 are integrated into one piece.

As shown in FIGS. 1 to 17, in the illustrated embodiment, the armature 73 and the movable leaf spring 71 are respectively joined to the upper and lower sides of the insulator 72, and grooves 72a and/or ribs are formed on the front and rear sides of the insulator 72 to increase the creepage distance between the armature 73 and the movable leaf spring 71.

As shown in FIGS. 1 to 17, in the illustrated embodiment, the movable leaf spring 71 includes a sheet-like body 710 and multiple bent wings 711. Multiple bent wings 711 are connected to one end of the sheet-like body 710 and bent vertically relative to the sheet-like body 710. One end of the sheet-like body 710 and multiple bent wings 711 are joined to the insulator 72 to increase the bonding force between the movable leaf spring 71 and the insulator 72.

As shown in FIGS. 1 to 17, in the illustrated embodiment, the armature 73 includes a plate-shaped body 730 and a bent portion 731. The bent portion 731 is connected to one end of the plate-shaped body 730 and bent perpendicular to the plate-shaped body 730. The bent portion 731 is joined into the insulator 72, and the plate-shaped body 730 is adapted to be movably mounted on the yoke 75.

As shown in FIGS. 1 to 17, in the illustrated embodiment, the relay further includes a reset leaf spring 74. The reset leaf spring 74 is fixed to the yoke 75 and pressed onto the armature 73, used to reset the armature 73 from the suction position to the initial position. The magnetic core 76 and the reset leaf spring 74 are respectively arranged on both sides of the yoke 75. The magnetic core 76 is used to apply electromagnetic attraction to the armature 73, and the reset leaf spring 74 is used to apply elastic reset force to the armature 73.

As shown in FIGS. 1 to 17, in the illustrated embodiment, the yoke 75 includes a vertical plate 750 and a horizontal plate 751. A notch 753 is formed at the upper end of the vertical plate 750. The lower end of horizontal plate 751 is connected to the lower end of vertical plate 750. The lower end of the magnetic core 76 is fixed to the horizontal plate 751 of the yoke 75. On the plate-shaped body 730 of the armature 73, there is a neck 73a formed, which is movably engaged in the notch 753 of the yoke 75.

As shown in FIGS. 1 to 17, in the illustrated embodiment, the yoke 75 is fixed in the slot of the insulation base 1 in the transverse direction X and longitudinal direction Y, and the yoke 75 is fixed to the bottom wall 12 of the insulation base 1 in the height direction Z by glue. The magnetic core 76 is riveted into the rivet hole of the horizontal plate 751 of the yoke 75.

As shown in FIGS. 1 to 17, in the illustrated embodiment, the reset leaf spring 74 includes a vertical spring piece 740 and a pressing spring piece 741. The vertical spring piece 740 is fixed to the vertical plate 750 of the yoke 75. The upper end of the pressing spring piece 741 is connected to the vertical spring piece 740 and bent at a predetermined angle relative to the vertical spring piece 740. A mounting port 73b is formed in one end of the plate-shaped body 730 of the armature 73 to allow the vertical spring piece 740 to pass through. The pressing spring piece 741 is pressed against one side of the mounting port 73b of the armature 73 to apply elastic reset force to the armature 73.

As shown in FIGS. 1 to 17, in the illustrated embodiment, a snap slot 75a is formed in the vertical plate 750 of the yoke 75, and an elastic buckle 74a is formed on the vertical spring piece 740 of the reset leaf spring 74. The elastic buckle 74a is engaged into the snap slot 75a to fix the reset leaf spring 74 to the yoke 75.

As shown in FIGS. 1 to 17, in the illustrated embodiment, a vertical slot 13a is formed in the side of the partition wall 13 of the insulation base 1 facing the vertical plate 750 of the yoke 75, and the vertical spring piece 740 of the reset leaf spring 74 is inserted into the vertical slot 13a of the partition wall 13.

As shown in FIGS. 1 to 17, in the illustrated embodiment, the reset leaf spring 74 further includes a limit spring piece 742, which is connected to the upper end of the vertical spring piece 740 and located above the other side of the mounting port 73b of the armature 73. The limit spring piece 742 is used to constrain the neck 73a of the armature 73 in the notch 753 of the yoke 75, in order to prevent the armature 73 from detaching from the yoke 75.

As shown in FIGS. 1 to 17, in the illustrated embodiment, the relay also includes a coil assembly. The coil assembly includes a coil skeleton 78, a coil 77, and two coil terminals 77a. The coil skeleton 78 has a central through-hole. The coil 77 is wound around the coil skeleton 78. Two coil terminals 77a are fixed to the coil skeleton 78 and connected to the two ends of the coil 77, respectively. The coil terminal 77a extends from the bottom wall 12 of the insulation base 1. The magnetic core 76 is installed in the central through-hole of the coil skeleton 78, and the upper end of the magnetic core 76 is exposed from the outside of the coil skeleton 78 for attracting the armature 73.

As shown in FIGS. 1 to 17, in the illustrated embodiment, when the coil 77 is energized, the armature 73 is attracted to the suction position by the electromagnetic attraction of the magnetic core 76, and the two movable contacts 4a are moved to the closed position where they are in electrical contact with the two static contacts 5a, respectively. When the coil 77 are deenergized, the electromagnetic attraction force applied to the armature 73 disappears, and the armature 73 is reset to its initial position under the elastic reset force of the reset leaf spring 74, and the two movable contacts 4a are moved to the open position separated from the two static contacts 5a.

As shown in FIGS. 1 to 17, in the illustrated embodiment, the peripheral wall 11 of the insulation base 1 is inserted into the housing 2 through the bottom opening of the housing 2. A protrusion 1a is formed on the outer side of the peripheral wall 11 of the insulation base 1, and a slot hole 2a is formed in the peripheral wall of the housing 2. The protrusion 1a is engaged into the slot hole 2a to fix the housing 2 to the insulation base 1.

As shown in FIGS. 1 to 17, in the illustrated embodiment, a positioning step 1b is formed on the outer side of the peripheral wall 11 of the insulation base 1, and the positioning step 1b is pressed against the bottom surface 2b of the housing 2 to position the housing 2 in the height direction Z of the insulation base 1.

As shown in FIGS. 1 to 17, in another exemplary embodiment of the present invention, a relay armature assembly is also disclosed. The relay armature assembly includes: an armature 73, a movable leaf spring 71, and an insulator 72. The armature 73 is suitable for being movably installed on the yoke 75 of the relay, and can swing relative to the yoke 75 between an initial position and a suction position. The movable leaf spring 71 is suitable for being connected to a movable contact assembly of the relay, for applying elastic contact force to the movable contact assembly. The armature 73 and the movable leaf spring 71 are fixed to the insulator 72 and electrically isolated from each other by the insulator 72.

As shown in FIGS. 1 to 17, in the illustrated embodiment, the insulator 72 is an injection molded part directly formed on the armature 73 and the movable leaf spring 71 through an embedded injection molding process, so that the armature 73, the movable leaf spring 71, and the insulator 72 are integrated into one piece.

As shown in FIGS. 1 to 17, in the illustrated embodiment, the armature 73 and the movable leaf spring 71 are respectively joined to the upper and lower sides of the insulator 72, and grooves 72a and/or ribs are formed on the front and rear sides of the insulator 72 to increase the creepage distance between the armature 73 and the movable leaf spring 71.

As shown in FIGS. 1 to 17, in the illustrated embodiment, the movable leaf spring 71 includes a sheet-like body 710 and multiple bent wings 711. Multiple bent wings 711 are connected to one end of the sheet-like body 710 and bent vertically relative to the sheet-like body 710. One end of the sheet-like body 710 and multiple bent wings 711 are joined to the insulator 72 to increase the bonding force between the movable leaf spring 71 and the insulator 72.

As shown in FIGS. 1 to 17, in the illustrated embodiment, through holes are formed in one end of the sheet-like body 710 and the bent wing 711, respectively, to engage with the insulator 72, in order to further increase the bonding force between the movable leaf spring 71 and the insulator 72.

As shown in FIGS. 1 to 17, in the illustrated embodiment, a riveting hole 712 is formed in the other end of the sheet-like body 710 of the movable leaf spring 71, which is suitable for engaging with the riveting post 41 on the movable contact assembly, so that the movable contact assembly can be riveted to the other end of the sheet-like body 710 of the movable leaf spring 71.

As shown in FIGS. 1 to 17, in the illustrated embodiment, the armature 73 includes a plate-shaped body 730 and a bent portion 731. The bent portion 731 is connected to one end of the plate-shaped body 730 and bent perpendicular to the plate-shaped body 730. The bent portion 731 is joined into the insulator 72, and the plate-shaped body 730 is adapted to be movably mounted on the yoke 75. A through-hole is formed in the bent portion 731 to engage with the insulator 72, in order to further increase the bonding force between the armature 73 and the insulator 72.

As shown in FIGS. 1 to 17, in another exemplary embodiment of the present invention, a relay module is also disclosed. The relay module includes a magnetic core 76, a yoke 75, a relay armature assembly, and a reset leaf spring 74. The yoke 75 is fixed to the insulation base 1. The lower end of magnetic core 76 is fixed to the yoke 75. The armature 73 of the relay armature assembly is movably mounted on the yoke 75, and can swing between the suction position in contact with the upper end of the magnetic core 76 and the initial position separated from the upper end of the magnetic core 76. The reset leaf spring 74 is fixed to the yoke 75 and pressed onto the armature 73, used to reset the armature 73 from the suction position to the initial position. The magnetic core 76 and the reset leaf spring 74 are respectively arranged on both sides of the yoke 75. The magnetic core 76 is used to apply electromagnetic attraction to the armature 73, and the reset leaf spring 74 is used to apply elastic reset force to the armature 73.

As shown in FIGS. 1 to 17, in the illustrated embodiment, the yoke 75 includes a vertical plate 750 and a horizontal plate 751. A notch 753 is formed at the upper end of the vertical plate 750. The lower end of horizontal plate 751 is connected to the lower end of vertical plate 750. The lower end of the magnetic core 76 is fixed to the horizontal plate 751 of the yoke 75. On the plate-shaped body 730 of the armature 73, there is a neck 73a formed, which is movably engaged in the notch 753 of the yoke 75.

As shown in FIGS. 1 to 17, in the illustrated embodiment, the yoke 75 is fixed in the slot of the insulation base 1 in the transverse direction X and longitudinal direction Y, and the yoke 75 is fixed to the bottom wall 12 of the insulation base 1 in the height direction Z by glue. The magnetic core 76 is riveted into the rivet hole of the horizontal plate 751 of the yoke 75.

As shown in FIGS. 1 to 17, in the illustrated embodiment, the reset leaf spring 74 includes a vertical spring piece 740 and a pressing spring piece 741. The vertical spring piece 740 is fixed to the vertical plate 750 of the yoke 75. The upper end of the pressing spring piece 741 is connected to the vertical spring piece 740 and bent at a predetermined angle relative to the vertical spring piece 740. A mounting port 73b is formed in one end of the plate-shaped body 730 of the armature 73 to allow the vertical spring piece 740 to pass through. The pressing spring piece 741 is pressed against one side of the mounting port 73b of the armature 73 to apply elastic reset force to the armature 73.

As shown in FIGS. 1 to 17, in the illustrated embodiment, a snap slot 75a is formed in the vertical plate 750 of the yoke 75, and an elastic buckle 74a is formed on the vertical spring piece 740 of the reset leaf spring 74. The elastic buckle 74a is engaged in the snap slot 75a to fix the reset leaf spring 74 to the yoke 75.

As shown in FIGS. 1 to 17, in the illustrated embodiment, the reset leaf spring 74 further includes a limit spring piece 742, which is connected to the upper end of the vertical spring piece 740 and located above the other side of the mounting port 73b of the armature 73. The limit spring piece 742 is used to constrain the neck 73a of the armature 73 in the notch 753 of the yoke 75, in order to prevent the armature 73 from detaching from the yoke 75.

As shown in FIGS. 1 to 17, in the illustrated embodiment, the relay module also includes a coil assembly. The coil assembly includes a coil skeleton 78, a coil 77, and two coil terminals 77a. The coil skeleton 78 has a central through-hole. The coil 77 is wound around the coil skeleton 78. Two coil terminals 77a are fixed to the coil skeleton 78 and connected to the two ends of the coil 77, respectively. The magnetic core 76 is installed in the central through-hole of the coil skeleton 78, and the upper end of the magnetic core 76 is exposed from the outside of the coil skeleton 78 for attracting the armature 73.

As shown in FIGS. 1 to 17, in another exemplary embodiment of the present invention, a relay is also disclosed. The relay includes: a housing 2, a relay module, an insulation base 1, and two static contact assemblies. The housing 2 has a bottom opening. The relay module is located in the housing 2. The insulation base 1 is installed into the bottom opening of the housing 2. Two static contact assemblies are fixed to the insulation base 1 for electrical contact with the movable contact assembly.

As shown in FIGS. 1 to 17, in the illustrated embodiment, the movable contact assembly includes a movable terminal 4 and two movable contacts 4a. The movable terminal 4 is fixed to the movable leaf spring 71. Two movable contacts 4a are respectively fixed to both ends of the movable terminal 4. The static contact assembly includes: a static terminal 5 and a static contact 5a. The static terminal 5 is fixed to the insulation base 1. The static contact 5a is fixed to the static terminal 5. Two movable contacts 4a are used to make electrical contact with the static contacts 5a of two static contact assemblies, respectively, to electrically connect the static terminals 5 of the two static contact assemblies.

As shown in FIGS. 1 to 17, in the illustrated embodiment, when the armature 73 is attracted to the suction position, the two movable contacts 4a are moved to the closed position in electrical contact with the two static contacts 5a, respectively. When the armature 73 is reset to its initial position, the two movable contacts 4a are moved to the open position separated from the two static contacts 5a.

As shown in FIGS. 1 to 17, in the illustrated embodiment, the insulation base 1 includes a peripheral wall 11, a bottom wall 12, and a partition wall 13. The bottom wall 12 is connected to the bottom of the peripheral wall 11. The partition wall 13 is connected to the peripheral wall 11 and the bottom wall 12. The partition wall 13 divides the internal space defined by the housing 2 and the insulation base 1 into a containment chamber 10a and an arc extinguishing chamber 10b. The coil assembly and the yoke 75 are arranged in the accommodating chamber 10a, and the movable contact assembly and the static contact assembly are arranged in the arc extinguishing chamber 10b.

As shown in FIGS. 1 to 17, in the illustrated embodiment, the relay further comprises two arc extinguishing magnets 6, which are arranged in the arc extinguishing chamber 10b. There are two recesses 101 formed on the inner side of the bottom wall 12 of the arc extinguishing chamber 10b, which are located below the two movable contacts 4a and between the two arc extinguishing magnets 6. This allows the electric arc 1c between one static contact 5a and one movable contact 4a of the relay to be pulled down into the recess 101 by the magnetic field between the two arc extinguishing magnets 6, thereby increasing the length of the electric arc 1c being pulled down.

As shown in FIGS. 1 to 17, in the illustrated embodiment, the insulation base 1 further includes two magnet retaining portions 14, which are formed in the arc extinguishing chamber 10b. A slot 14a is formed in the magnet retaining portion 14, and two arc extinguishing magnets 6 are respectively inserted into the slots 14a of the two magnet retaining portions 14.

As shown in FIGS. 1 to 17, in the illustrated embodiment, the slot 14a has an insertion port located on the outer side of the bottom wall 12, and the arc extinguishing magnet 6 is inserted into the slot 14a of the magnet retaining portion 14 through the insertion port.

As shown in FIGS. 1 to 17, in the illustrated embodiment, the insulation base 1 further includes two terminal holding portions 15, which are formed in the arc extinguishing chamber 10b. A terminal slot 15a is formed in the terminal holding portion 15, and two static terminals 5 are respectively inserted into the terminal slots 15a of the two terminal holding portions 15.

As shown in FIGS. 1 to 17, in the illustrated embodiment, the peripheral wall 11 of the insulation base 1 is inserted into the housing 2 through the bottom opening of the housing 2. A protrusion 1a is formed on the outer side of the peripheral wall 11 of the insulation base 1, and a slot hole 2a is formed in the peripheral wall of the housing 2. The protrusion 1a is engaged with the slot hole 2a to fix the housing 2 to the relay insulation base 1.

As shown in FIGS. 1 to 17, in the illustrated embodiment, a vertical slot 13a is formed in the side of the partition wall 13 of the insulation base 1 facing the vertical plate 750 of the yoke 75, and the vertical spring piece 740 of the reset leaf spring 74 is inserted into the vertical slot 13a of the partition wall 13.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A relay armature assembly, comprising:
an armature which is suitable for being movably installed on a yoke of a relay, and can swing relative to the yoke between an initial position and a suction position;
a movable leaf spring adapted to be connected to a movable contact assembly of the relay, for applying elastic contact force to the movable contact assembly; and
an insulator,
wherein the armature and the movable leaf spring are fixed to the insulator and electrically isolated from each other by the insulator.

2. The relay armature assembly according to claim 1,
wherein the insulator is an injection molded part directly formed on the armature and the movable leaf spring through an embedded injection molding process, so that the armature, the movable leaf spring, and the insulator are integrated into one piece.

3. The relay armature assembly according to claim 1,
wherein the armature and the movable leaf spring are respectively joined to upper and lower sides of the insulator, and grooves and/or ribs are formed on front and rear sides of the insulator to increase a creepage distance between the armature and the movable leaf spring.

4. The relay armature assembly according to claim 2,
wherein the movable leaf spring comprises:
a sheet-like body; and
multiple bent wings connected to one end of the sheet-like body and bent vertically relative to the sheet-like body,
wherein one end of the sheet-like body and the multiple bent wings are joined into the insulator to increase a bonding force between the movable leaf spring and the insulator.

5. The relay armature assembly according to claim 4,
wherein through holes are formed in one end of the sheet-like body and in the bent wing respectively to engage with the insulator, in order to further increase the bonding force between the movable leaf spring and the insulator.

6. The relay armature assembly according to claim 4,
wherein a riveting hole is formed in the other end of the sheet-like body of the movable leaf spring, which is suitable for engaging with a riveting post on the movable contact assembly, so that the movable contact assembly can be riveted to the other end of the sheet-like body of the movable leaf spring.

7. The relay armature assembly according to claim 1,
wherein the armature comprises:
a plate-shaped body; and
a bent portion connected to one end of the plate-shaped body and bent perpendicular to the plate-shaped body,
wherein the bent portion is joined into the insulator, and the plate-shaped body is adapted to be movably mounted on the yoke,
wherein a through hole is formed in the bent portion to engage with the insulator, in order to further increase a bonding force between the armature and the insulator.

8. A relay module, comprising:
a yoke which is fixed to the insulation base of a relay;
a magnetic core with its lower end fixed to the yoke;
the relay armature assembly according to claim 1, wherein the armature is movably mounted on the yoke and can swing between a suction position in contact with the upper end of the magnetic core and an initial position separated from the upper end of the magnetic core; and
a reset leaf spring fixed to the yoke and pressed onto the armature, used to reset the armature from the suction position to the initial position,
wherein the magnetic core and the reset leaf spring are respectively arranged on both sides of the yoke, the magnetic core is used to apply electromagnetic attraction to the armature, and the reset leaf spring is used to apply elastic reset force to the armature.

9. The relay module according to claim 8,
wherein the yoke comprises:
a vertical plate with a notch formed at the upper end of the vertical plate; and
a horizontal plate connected to the lower end of the vertical plate,
wherein a neck is formed on the body of the armature, the neck is movably engaged in the notch of the yoke.

10. The relay module according to claim 9,
wherein the reset leaf spring comprises:
a vertical spring piece fixed to the vertical plate of the yoke; and
a pressing spring piece connected to the upper end of the vertical spring piece and bent at a predetermined angle relative to the vertical spring piece,
wherein a mounting port is formed in one end of the plate-shaped body of the armature to allow the vertical spring piece to pass through, and the pressing spring piece is pressed on one side of the mounting port of the armature to apply elastic reset force to the armature.

11. The relay module according to claim 10,
wherein a snap slot is formed in the vertical plate of the yoke, and an elastic buckle is formed on the vertical spring piece of the reset leaf spring, the elastic buckle is engaged into the snap slot to fix the reset leaf spring to the yoke.

12. The relay module according to claim 10,
wherein the reset leaf spring further comprises:
a limit spring piece connected to the upper end of the vertical spring piece and located above the other side of the mounting port of the armature,
wherein the limit spring piece is used to constrain the neck of the armature in the notch of the yoke to prevent the armature from detaching from the yoke.

13. The relay module according to claim 8, further comprising:
a coil assembly, including:
a coil skeleton with a central through-hole;
a coil wound around the coil skeleton; and
two coil terminals fixed to the coil skeleton and connected to both ends of the coil, respectively,
wherein the magnetic core is installed in the central through-hole of the coil skeleton, and the upper end of the magnetic core is exposed from the outside of the coil skeleton for adsorbing the armature.

14. A relay, comprising:
a housing with a bottom opening;
the relay module according to claim 8, which is arranged in the housing;
an insulation base installed into the bottom opening of the housing; and
two static contact assemblies fixed to the insulation base for electrical contact with a movable contact assembly.

15. The relay according to claim 14,
wherein the movable contact assembly comprises:
a movable terminal fixed to the movable leaf spring; and
two movable contacts respectively fixed to both ends of the movable terminal,
wherein the static contact assembly comprises:
a static terminal fixed to the insulation base; and
a static contact fixed to the static terminal,
wherein the two movable contacts are used to make electrical contact with static contacts of the two static contact assemblies, respectively, to electrically connect the static terminals of the two static contact assemblies.

16. The relay according to claim 15,
wherein when the armature is attracted to the suction position, the two movable contacts are moved to a closed position in electrical contact with the two static contacts respectively;
wherein when the armature is reset to the initial position, the two movable contacts are moved to an open position separated from the two static contacts.

17. The relay according to claim 15,
wherein the insulation base comprises:
a peripheral wall;
a bottom wall connected to the bottom of the peripheral wall; and
a partition wall connected to the peripheral wall and the bottom wall,
wherein the partition wall divides an internal space defined by the housing and the insulation base into a containment chamber and an arc extinguishing chamber,
wherein the coil assembly and the yoke are arranged in an accommodating chamber, and the movable contact assembly and the static contact assembly are arranged in the arc extinguishing chamber.

18. The relay according to claim 17, further comprising:
two arc extinguishing magnets which are arranged in the arc extinguishing chamber,
wherein two recesses are formed on the inner side of the bottom wall of the arc extinguishing chamber, the two recesses are respectively located below the two movable contacts and between the two arc extinguishing magnets, so that an electric arc between one static contact and one movable contact of the relay can be pulled down into the recess by a magnetic field between the two arc extinguishing magnets to increase the length of the electric arc being pulled down.

19. The relay according to claim 18,
wherein the insulation base further comprises:
two magnet retaining portions which are formed in the arc extinguishing chamber, wherein a slot is formed in the magnet retaining portion, and the two arc extinguishing magnets are respectively inserted into slots of the two magnet retaining portions.

20. The relay according to claim 19,
wherein the slot has an insertion port located on the outer side of the bottom wall, and the arc extinguishing magnet is inserted into the slot of the magnet retaining portion through the insertion port.

21. The relay according to claim 19,
wherein the insulation base further comprises:
two terminal holding portions which are formed in the arc extinguishing chamber, wherein a terminal slot is formed in the terminal holding portion, and the two static terminals are respectively inserted into the terminal slots of the two terminal holding portions.

22. The relay according to claim 17,
wherein the peripheral wall of the insulation base is inserted into the housing through the bottom opening of the housing, and a protrusion is formed on the outer side of the peripheral wall of the insulation base, a slot hole is formed in the peripheral wall of the housing, and the protrusion is engaged with the slot hole to fix the housing to the insulation base.

23. The relay according to claim 17,
wherein a vertical slot is formed in one side of the partition wall of the insulation base facing the vertical plate of the yoke, and the vertical spring piece of the reset leaf spring is inserted into the vertical slot of the partition wall.
